(19) United States
(12) Patent Application Publication
(10) Pub. No.: US 2019/0220935 A1
(43) Pub. Date: Jul. 18, 2019

(54) System And Method To Permit A Live Person To Show and Stage Real Property From A remote Location

(71) Applicant: The Brutus Trust, North Las Vegas, NV (US)

(72) Inventor: Kory Scheeler, Las Vegas, NV (US)

(21) Appl. No.: 16/248,075

(22) Filed: Jan. 15, 2019

Related U.S. Application Data
(60) Provisional application No. 62/617,473, filed on Jan. 15, 2018.

(51) Int. Cl. G06Q 50/16; H04L 29/08; H04M 3/42; H04W 4/16; H04L 12/18

(52) U.S. Cl. CPC G06Q 50/163; H04L 67/125; H04L 12/1827; H04W 4/16; H04M 3/42229

(57) ABSTRACT

A method and apparatus to permit a live person to show and stage real property, such as a customer or potential customer, from a remote location, is disclosed.

### FIELD OF THE INVENTION

The present invention relates to a system and method to permit a live person to stage and show real property, to a party, such as a customer, potential customer, or other interested party, from a remote location.

### BACKGROUND

Often when a piece of real property is available for sale, lease, or other disposition, the property may be made available to potential customers, or other interested parties, to view the property. This may be done by providing the potential customers or other interested parties with photographs or videos of the property, and/or other literature describing the property. But these might not be adequate. The property may also be shown by having a live person available at the property to permit the potential customers or other interested parties to physically visit and inspect the property. However this can be relatively expensive and difficult to coordinate between the person showing the property and the potential customers or other interested parties

### SUMMARY

In accordance with the present invention, it is an object to provide a system and method to permit a live person to show and stage real property, such as for potential customers or other interested parties.

### BRIEF DESCRIPTION OF THE DRAWINGS

For a more complete understanding of the disclosure, reference should be made to the following detailed description and accompanying drawings, wherein:

FIGS. 1A and 1B illustrate one embodiment of the present invention such as in conjunction with a house for sale and/or lease; and

FIG. 2 is a flow chart of the embodiment of FIG. 1.

### DESCRIPTION OF THE PREFERRED EMBODIMENT

It is to be understood that this disclosure is not intended to limit the invention to any particular form described, but to the contrary, the invention is intended to include all modifications, alternatives and equivalents falling within the spirit and scope of the invention as defined by the appended claims.

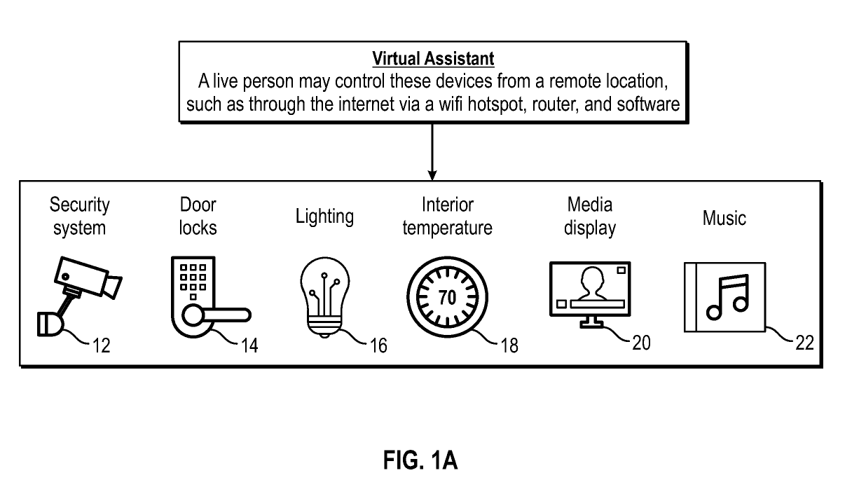

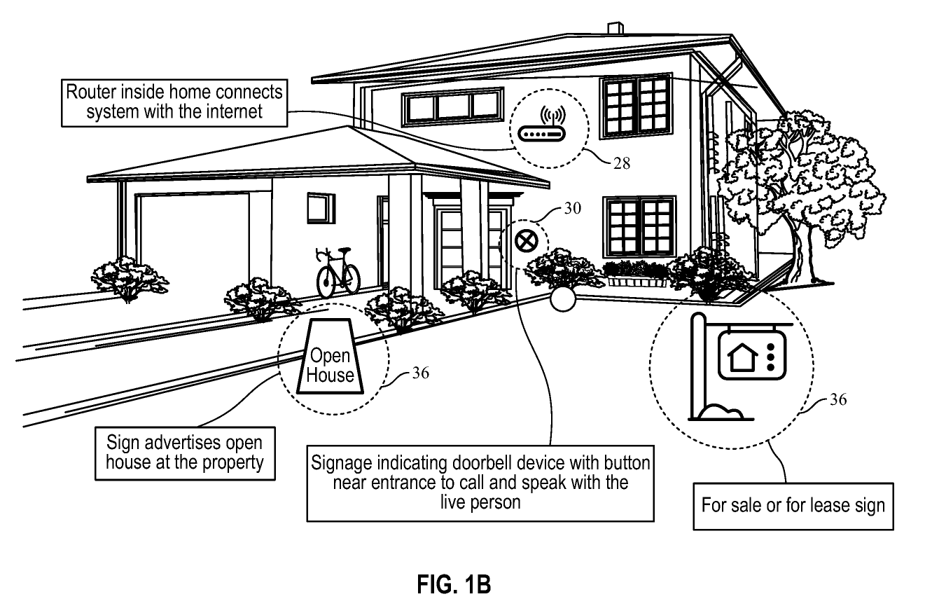

In accordance with the present invention, a virtual assistant 8 is illustrated in FIGS. 1A and 1B. The virtual assistant 8 may be utilized to assist in the sale, lease, or other disposal of real property 10, such as a house.

The virtual assistant 8, which may be located at the property 10, may include conventional, remotely operable, property access and control devices, which may be Wi-Fi enabled, such as a remotely operable security system 12, door locks 14, interior and exterior lighting 16, interior temperature control 18, media displays 20 and sound/music system 22. The virtual assistant 8 may also have a wireless router 28 coupled to the internet, such as via a cellular connection, such as a conventional hotspot, providing Wi-Fi connectability between home access and control devices and the internet. The property access and control devices of the virtual assistant 8 may further include a doorbell device 30 with voice communication. The property access and control devices of the virtual assistant 8 may further include a mobile communication device. The property 10 may also have conventional advertising signage 36.

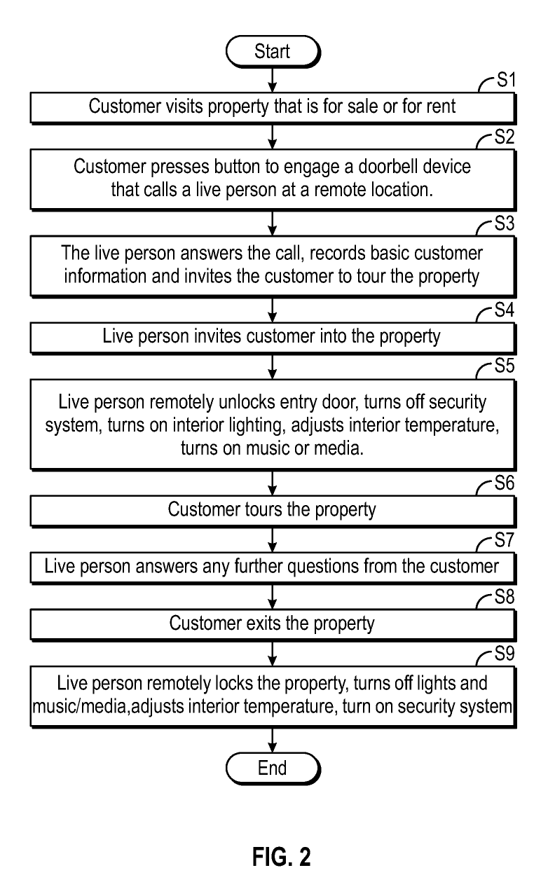

Referring to FIG. 2, in a step S1, a customer, potential customer or other interested party (hereinafter, “customer”) may visit the property 10 that may be for sale or for lease. The customer may walk up to the entry door of the house after viewing the signage 36, such as a for sale sign, for rent sign, open house sign or otherwise. The customer may also have a pre-scheduled appointment with the seller or agent for the property 10.

In a step S2, the signage 36 at the entrance of the property may indicates that immediate access to tour the property is available via the virtual assistant 8 by activating the doorbell device 30, such as by pressing a doorbell button associated with the doorbell device 30. The doorbell device 30 may be a commercially available Wi-Fi or Bluetooth enabled doorbell/camera/speaker device. The customer may press the doorbell button for the device 30, near the entry door of the house. The doorbell button may engage the device 30, and the device 30 may connect with the router 28 inside the property 10. The router 28 may make an internet connection via a commercially available cellular connection. The Wi-Fi enabled devices may communicate with each other via either a software system. The software system may be a custom designed software system or a commercially available software system. Through these Wi-Fi enabled devices and steps, a live person, such as an agent representing the seller of the property 10 and who may be located at a location remote from the property 10, may be contacted. The live person may have remote access to, and control of, the virtual assistant 8, and its associated property access and control devices, via a remote communication device.

In steps S3-S4, the live person may answer the call, from the remote location, and speak with the customer through the doorbell/camera/speaker device 30. The live person may ask the customer basic information such as name and contact information. The live person may provide information about the property 10, and may then invite the customer to tour the property.

In step S5, through the virtual assistant 8 installed at the property 10, the live person may stage the property to be shown to the customer, allow the customer to enter and tour the property and answer questions the customer might have. All from a remote location. Specifically the live person may remotely: (a) unlock the commercially available smart entry door lock by sending a command to the smart entry door lock through the internet and the software system; (b) turn off the commercially available security system 12 through the internet and the software system; (c) turn on the interior lighting 16 via commercially available Wi-Fi or Bluetooth enabled light bulbs or light switches that are connected to the internet and the software system; (d) adjust the interior heating or cooling temperature of the home, such as via a commercially available Wi-Fi or Bluetooth enabled thermostat 18 that is connected to the internet and the software system; (e) turn on the commercially available media displays 20 that are connected to the internet and the software system; and/or (f) turn on the commercially available music system 22 that is connected to the internet and the software system.

In a step S6, the customer may tour the property 10, that may be for sale, for rent, or otherwise available.

In a step S7, the customer may communicate with the live person for further information, such as by pressing the button on the doorbell/camera/speaker device 30 near the entrance, or utilizing the mobile communication device. The customer may further be provided additional information, such as by communication via the virtual assistant 8 with a loan officer, such as of a bank or other financial institution.

In a step S8, the customer may exit the house when finished touring.

In a step S9, using the virtual assistant 8, the live person may remotely lock the entry doors, turn off the interior lights, turn off the music and/or media, adjusts the interior temperature, turn on the security system, or any other necessary and/or desirable tasks.

A preferred embodiment of this invention has been described herein. It should be understood that the illustrated embodiment is exemplary only and should not be taken as limiting the scope of the invention.

What is claimed is:

1. A method of showing real property to a party, from a location remote from the real property, the method comprising:
providing a virtual assistant at the real property, the virtual assistant including at least one property access and control device operable from a remote location;
providing a live agent at the remote location, the live agent having operational control of the at least one property access and control device, via the virtual assistant, from the remote location; and
permitting the live agent to communicate with the party and operate the at least one property access and control device as the party tours the real property.

2. The method of claim 1, wherein the at least one property access and control device includes a remotely operable door lock.

3. The method of claim 1, wherein the at least one property access and control device includes a remotely operable security system.

4. The method of claim 1, wherein the at least one property access and control device includes a remotely sound system.

5. The method of claim 1, wherein the at least one property access and control device includes a remotely operable media display.

6. The method of claim 1, wherein the at least one property access and control device includes a voice communication device for permitting voice communication between the party and the agent.

7. A system for facilitating a showing of real property to a party, located at the real property, by a live agent located at a location remote from the real property, the system comprising:
a virtual assistant located at the real property, the virtual assistant including at least one property access and control device operable by the live agent;
a remote communication device located with the live agent and adapted to provide the live agent operational control of the at least one property access and control device, via the virtual assistant;
wherein the live agent communicates with the party and operate the at least one property access and control device as the customer tours the real property.

8. The method of claim 7, wherein the at least one property access and control device includes a remotely operable door lock.

9. The method of claim 7, wherein the at least one property access and control device includes a remotely operable security system.

10. The method of claim 7, wherein the at least one property access and control device includes a remotely sound system.

11. The method of claim 7, wherein the at least one property access and control device includes a remotely operable media display.

12. The method of claim 7, wherein the at least one property access and control device includes a voice communication device for permitting voice communication between the party and the agent.

13. A method of showing real property to a party, from a location remote from the real property, the method comprising:
permitting the party to activate a doorbell device to initiate a call live person located at a location remote from the real property;
permitting the live person to answer the call, record certain party information, and invite the party to enter the property;
permitting the live person to remotely unlock a door to the property, turn-off a security system to the property, and stage the property for showing to the party;
permitting the party to tour the staged property;
permitting the live person to remotely answer questions posed by the party;
permitting the party to exit the property upon completion of the staged property tour; and
permitting the live person to remotely re-lock the door to the property and un-stage the property.

14. The method of claim 13, wherein the step of remotely staging the property includes the step of remotely adjusting the temperature of the property.

15. The method of claim 13, wherein the step of remotely staging the property includes the step of remotely adjusting interior lighting at the property.

16. The method of claim 13, wherein the step of remotely staging the property includes the step of remotely turning on a sound system at the property.

17. The method of claim 13, wherein the step of remotely staging the property includes the step of remotely adjusting media playing at the property.
